(19) United States
(12) Patent Application Publication
(10) Pub. No.: US 2008/0010837 A1
(43) Pub. Date: Jan. 17, 2008

(54) Fluid-driven cutting device

(76) Inventor: William Weissenborn, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 11/485,403

(22) Filed: Jul. 12, 2006

(51) Int. Cl. B26B 15/00

(52) U.S. Cl. 30/241; 30/228

(57) ABSTRACT

A pruning device that includes a blade, a housing for the blade, a piston-and-cylinder unit, and an elongated, rigid member connecting the piston-and-cylinder unit to the blade. A tank containing compressed air operates the piston-and-cylinder unit which, in turn, drives the blade out of an inoperative position to cut an object. The blade is completely inside the housing in its inoperative position.

### BACKGROUND OF THE INVENTION

1. Field of the Invention

The invention relates to a cutting or shearing device.

2. Description of the Prior Art

Landscapers as well as homeowners employ a variety of devices for pruning trees, shrubs and the like. Many of these devices are electrically, hydraulically or pneumatically powered in order to reduce the stress on individuals using the devices. In all of these pruning devices, the cutting elements are exposed even when the devices are not being used.

One pruning device, which is designed for tree limbs or branches that are out of reach of an individual standing on the ground, consists of a long tube with a cutting element at one end thereof. Such end is also provided with a hook which has a cutting edge and is designed to receive a limb or branch to be cut. The cutting element is pivotal on the tube so that the cutting element can cooperate with the hook to shear a limb or branch received by the hook. The cutting element is operated by a flexible cable which extends to the end of the tube remote from the cutting element. This end of the tube is equipped with a piston-and-cylinder unit which is attached to the cable and is actuated by a motor-driven pump. Upon actuation of the pump, the piston moves in a direction away from the cutting element and causes the cable to exert a pull on the cutting element. The cutting element then pivots to sever a limb or branch held by the hook.

The cable extends from the cutting element to an opening in the tube near the cutting element. The cable enters the opening and then runs through the tube to the piston-and-cylinder unit. In the area of the opening, the cable rubs against the tube and is subject to wear.

### SUMMARY OF THE INVENTION

One aspect of the invention resides in a cutting device comprising at least one housing, a cutting element and means for moving the cutting element from an inoperative position to an operative position. The cutting element is completely inside the housing in the inoperative position and at least partially outside of the housing in the operative position.

The moving means can be designed to move the cutting element from the inoperative position to the operative position using compressed fluid. The compressed fluid is advantageously compressed gas.

The cutting device may further comprise means for effecting activation of the moving means. The means for effecting activation of the moving means can include a source of compressed gas and a manually operable element designed such that the moving means is subjected to a single burst of compressed gas each time the manually operable element is operated. By subjecting the moving means to a burst of compressed gas when the manually operable element is operated, the cutting element can be rapidly shifted from the inoperative position to the operative position.

The means for effecting activation of the moving means is preferably devoid of a motor.

The housing for the cutting element may define a path for the cutting element, and such path can extend at least partway from the inoperative position of the cutting element to the operative position thereof. The housing may comprise a pair of plates which define a gap having a first edge and an opposed second edge, and the housing may further comprise a first spacer in the gap in the region of the first edge and a second spacer in the gap in the region of the second edge. Here, the plates and spacers can cooperate to define the path of the cutting element.

The cutting device may comprise another housing which is spaced from the cutting element housing. The moving means can include a piston reciprocable in the other housing between a first position in which the cutting element is in the inoperative position and a second position in which the cutting element is in the operative position. The moving means can also include a force-transmitting element which bridges the cutting element housing and the piston housing, and this force-transmitting element may have one end which adjoins the piston and another end which adjoins the cutting element.

The force-transmitting element can be substantially inflexible, and the piston, the force-transmitting element and the cutting element may then be arranged such that the force-transmitting element pushes the cutting element from the inoperative position to the operative position in response to movement of the piston from its first position to its second position.

The cutting device can comprise an additional housing which is disposed between and bridges the cutting element housing and the piston housing, and the force-transmitting element here extends through the additional housing. The additional housing may comprise a tube and at least the major part of the force-transmitting element may be tubular. Such part of the force-transmitting element advantageously consists essentially of drawn-over-mandrel steel. It is preferred for the cutting element housing, the piston housing and the force-transmitting element housing to consist at least predominantly of aluminum or an alloy thereof.

The cutting element housing can be provided with a cutout for receiving an object to be cut, and the cutting element then projects into the cutout in the operative position. The cutout may have an open end, a closed end and an axis running between the open end and the closed end, and the axis advantageously diverges from the moving means in a direction from the open end to the closed end so as to facilitate placement of the cutout over an object to be cut. The cutout is preferably spaced from the previously mentioned manually operable activating element for the moving means by a distance such that a user operating the manually operable element can place the cutout over an object which is to be cut and is out of the reach of the user.

Another aspect of the invention resides in a cutting method.

One embodiment of the method comprises the steps of fully retracting a cutting element into a housing, cutting at least partway through an object by propelling at least part of the cutting element out of the housing and against the object, and fully retracting the cutting element into the housing following the cutting step.

The cutting element can be propelled out of the housing compressed fluid, preferably compressed gas. Advantageously, the cutting step is performed by subjecting the cutting element to the action of a single burst of compressed gas so as to rapidly move the cutting element towards the object to be cut.

Another embodiment of the cutting method comprises the step of cutting at least partway through an object by pushing or thrusting a cutting element, which is at least partially confined in a housing, out of an inoperative position and against the object. This embodiment of the method further comprises the steps of returning the cutting element to the inoperative position following the cutting step, and guiding the cutting element with the housing during the cutting step and the returning step.

Additional features and advantages of the invention will be forthcoming from the following detailed description of certain preferred embodiments when read in conjunction with the accompanying drawings.

### BRIEF DESCRIPTION OF THE DRAWINGS

FIG. 1 is a schematic central longitudinal sectional view of a cutting device in accordance with the invention.

FIG. 2 is a somewhat enlarged end view of a housing forming part of the cutting device of FIG. 1 as seen in the direction of the arrow A of FIG. 1.

### DESCRIPTION OF THE PREFERRED EMBODIMENTS

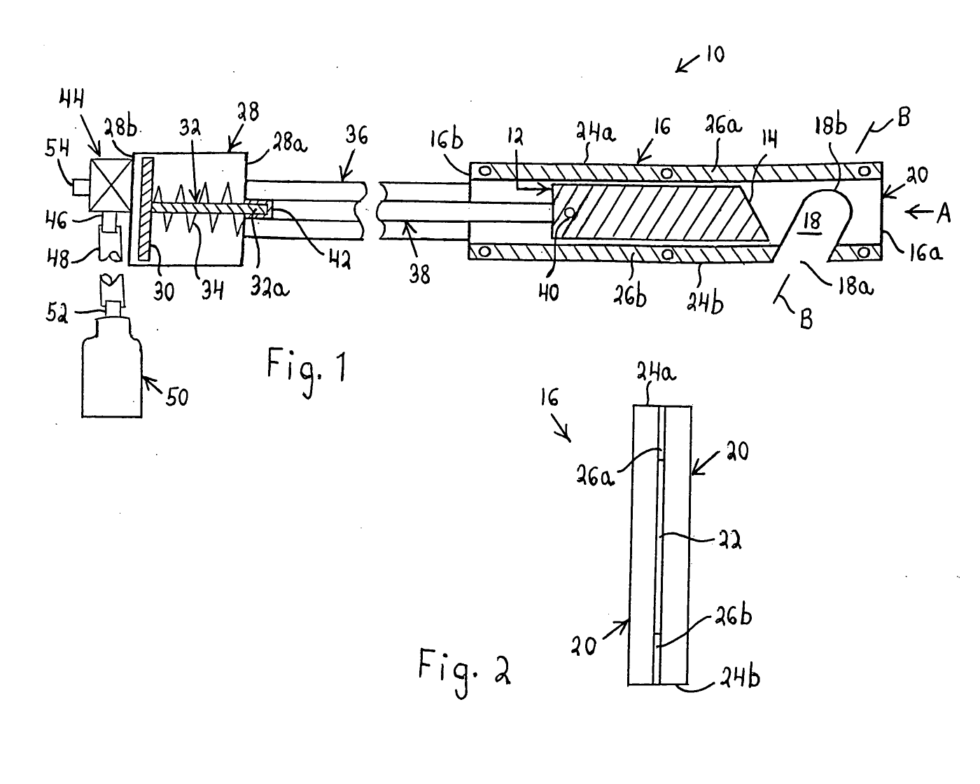

Referring to FIG. 1, a cutting or shearing device according to the invention is generally indicated by the numeral 10. The cutting device 10, which is designed to be portable in the sense that it can be carried around by a person using the cutting device 10, is intended primarily for the pruning or trimming of trees, shrubs and the like but could be used for other cutting or shearing operations as well.

The cutting device 10 comprises a cutting or shearing element in the form of a blade 12 having a cutting or shearing edge 14. An elongated housing 16 is provided for the blade 12, and the blade 12 is movable back-and-forth longitudinally of the blade housing 16 along a straight or linear path defined by the housing 16. The blade housing 16 has a longitudinal end 16a and an opposite longitudinal end 16b, and a cutout 18 is formed in the housing 16 in the vicinity of the longitudinal end 16a.

Considering FIG. 2, the blade housing 16 includes two parallel, rectangular plates 20 having the same dimensions. The plates 20 are juxtaposed in such a manner that a major surface of each plate 20 confronts a major surface of the other plate 20. The confronting major surfaces of the plates 20 are spaced from one another to define a gap 22 having a thickness somewhat greater than the thickness of the blade 12. The blade 12 is located in and movable along the gap 22, and the thickness of the gap 22 is selected such that the blade 12 can move easily along the gap 22 but has a restricted amount of play laterally.

Each of the plates 20 has a first longitudinal edge running lengthwise of the blade housing 16 and an opposite second longitudinal edge running lengthwise of the housing 16. The first longitudinal edge of each plate 20 is parallel to the second longitudinal edge thereof, and the first longitudinal edges of the two plates 20 are located in a common plane 24a while the second longitudinal edges of the two plates 20 are located in a common plane 24b parallel to the plane 24a. The gap 22 has a margin or marginal portion which adjoins the plane 24a and an opposite margin or marginal portion which adjoins the plane 24b. These two margins of the gap 22 run lengthwise of the plates 20 and the blade housing 16, and an elongated spacer 26a is situated in the margin adjoining the plane 24a while an elongated spacer 26b is situated in the margin adjoining the plane 24b. The spacer 26a has a longitudinal edge which runs lengthwise of the blade housing 16 and is located in the plane 24a whereas the spacer 26b has a longitudinal edge which runs lengthwise of the housing 16 and is located in the plane 24b. The spacer 26a runs from the longitudinal end 16a of the blade housing 16 to the longitudinal end 16b thereof.

For ease of description, and based on the showing in FIG. 1, the plane 24a will hereinafter be referred to as the upper edge of the blade housing 16. The plane 24b, on the other hand, will hereinafter be referred to as the lower edge of the blade housing 16.

Returning to FIG. 1, the cutout 18 extends from the lower edge 24b of the blade housing 16 towards the spacer 26a and preferably terminates somewhat short of the spacer 26a. Thus, due to the cutout 18, the spacer 26b and the lower housing edge 24b are each divided into two sections of unequal length longitudinally of the blade housing 16. The two sections of the spacer 26b are spaced from one another by the cutout 18 as are the two sections of the lower housing edge 24b. The shorter section of the spacer 26b, as well as the shorter section of the lower housing edge 24b, runs from the longitudinal end 16a of the blade housing 16 to the cutout 18. On the other hand, the longer section of the spacer 26b, as well as the longer section of the lower housing edge 24b, runs from the cutout 18 to the longitudinal end 16b of the blade housing 16.

The spacers 26a,26b are parallel to one another and separated from each other by a distance somewhat greater than the height of the blade 12. Hence, a central portion of the gap 22 having a height somewhat greater than that of the blade 12 is disposed between the spacers 26a,26b, and the blade 12 is confined in this central portion of the gap 22. The distance between the spacers 26a,26b is selected such that the blade 12 can move easily along the gap 22 but has a restricted amount of play in a direction from one of the spacers 26a,26b to the other.

The central portion of the gap 22, which contains the blade 12, has a constant height lengthwise of the blade housing 16 except in the region of the cutout 18 where the height of the gap 22 is decreased because of the cutout 18. The central portion of the gap 22 may be open at both longitudinal ends 16a, 16b of the blade housing 16.

The plates 20 and the spacers 26a,26b cooperate to define the path of movement of the blade 12 and to guide the blade 12 during movement thereof. The cutout 18 extends across at least part of such path thereby allowing the blade 12 to move into the cutout 18.

The cutout 18 functions to receive an object to be cut. The cutout 18 has an open end 18a at the lower housing edge 24b and a closed end 18b in the region of the spacer 26a. An object to be cut can be inserted in the open end 18a, and the object can then be brought into contact with the closed end 18b to allow the object to be firmly held during cutting.

The cutout 18 has an axis B-B which runs between the open end 18a and the closed end 18b. The axis B-B is inclined in such a manner that the axis B-B diverges from the longitudinal end 16b of the blade housing 16 as considered in a direction from the longitudinal end 16b towards the longitudinal end 16a of the housing 16. The inclination of the axis B-B facilitates the insertion of an object to be cut into the cutout 18.

The plates 20 and the spacers 26a,26b are held together by fastening elements 26, e.g., screws, which allow the blade housing 16 to be disassembled for cleaning and/or for replacement of the blade 12. In other words, the fastening elements 26 releasably connect the plates 20 and the spacers 26a,26b to one another.

The cutting device 10 further comprises a housing 28 which is spaced from the blade housing 16 and can be in the form of a cylinder of circular cross section. The housing 28 has opposed longitudinal ends, and one of the longitudinal ends of the housing 28 includes an end wall 28a which faces the blade housing 16 while the other longitudinal end of the housing 28 includes an end wall 28b which faces away from the housing 16. The housing 28 contains a piston 30 which is movable back-and-forth, or is reciprocable, in the housing 28 in a direction from one of the end walls 28a,28b to the other. A piston rod 32, which may be of circular cross section, is mounted on the piston 30 centrally of the piston housing 28 and extends from the piston 30 towards the end wall 28a. The end wall 28a is provided with a central opening, and the piston rod 32 passes through this opening and has an end portion 32a outside of the piston housing 28. The end portion 32a of the piston rod 32 is externally threaded.

If the piston housing 28 is a cylinder of circular cross section, the piston 30 is circular.

A biasing element in the form of a spring 34 surrounds the portion of the piston rod 32 inside the piston housing 28. The spring 34 has an end which bears against the piston 30 and an opposite end which bears against the end wall 28a of the housing 28.

The longitudinal end of the piston housing 28 with the end wall 28b is formed with an opening, and the end wall 28b consists of a removable cover which seals the opening and can, for instance, be held in place by a non-illustrated snap ring.

The piston housing 28, piston 30, piston rod 32 and spring 34 together constitute a piston-and-cylinder unit with the piston housing 28 functioning as a cylinder in which the piston 30 rides.

The blade housing 16 is joined to the piston housing 28 by an elongated tubular housing 36 which may be of circular cross section, and the tubular housing 36 bridges the blade housing 16 and the piston housing 28. The plates 20 of the blade housing 16 have end surfaces which face the piston housing 28, and the tubular housing 36 has opposed longitudinal ends including one which abuts these end surfaces of the plates 20. The other longitudinal end of the tubular housing 36 abuts the end wall 28a of the housing 28. The longitudinal ends of the tubular housing 36 may, for example, be provided with respective non-illustrated flanges which can be attached to the end surfaces of the plates 20 and to the end wall 28a via suitable, non-illustrated attachment means. Such attachment means are advantageously such that the tubular housing 36 can be disconnected from, and subsequently reattached to, the blade housing 16 and piston housing 28, i.e., it is advantageous for the attachment means to releasably connect the tubular housing 36 to the blade housing 16 and the piston housing 28. By way of example, the attachment means could be constituted by screws.

An elongated tube or tubular element 38, which can be of circular cross section, runs through the tubular housing 36 lengthwise of the latter. The blade housing 16 is formed with a non-illustrated passage which runs from the longitudinal end 16b of the housing 16 partway to the longitudinal end 16a, and this passage is designed to receive the tube 38 with clearance. The tube 38 extends from the tubular housing 36 into such passage and has a longitudinal end portion in the blade housing 16. This longitudinal end portion of the tube 38, which can be provided with a non-illustrated slot for the blade 12, is attached to the latter via a fastening element 40. Preferably, the fastening element 40 is of a type which can be removed to allow replacement of the blade 12, i.e., it is preferred for the fastening element 40 to be of a type which releasably secures the blade 12 to the tube 38. For instance, the fastening element 40 could be a threaded bolt which can be provided with a nut.

The tube 38 has another longitudinal end portion which adjoins the end wall 28a of the piston housing 28, and a plug 42 is mounted inside such longitudinal end portion of the tube 38. The plug 42, which may be in the form of a cylinder of circular cross section, is rigidly secured to the tube 38, e.g., by welding. The plug 42 is provided with an internally threaded bore having an open end and an opposite closed end. The open end of the bore in the plug 42 faces and is aligned with the opening which is formed in the end wall 28a of the piston housing 28 and receives the piston rod 32. The externally threaded end portion 32a of the piston rod 32, which is located outside of the piston housing 28, is screwed into the internally threaded bore of the plug 42. The piston 30 is thus in driving engagement with the blade 12 via the piston rod 32, the plug 42, the tube 38 and the fastening element 40.

The piston rod 32, plug 42 and tube 38 constitute components of an elongated force-transmitting element which functions to transfer force from the piston 30 to the blade 12. It is preferred for the piston rod 32, plug 42 and tube 38 to be essentially inflexible or rigid.

The piston 30 has a rest position which is illustrated in FIG. 1. In the rest position of the piston 30, the piston 30 is located near the removable cover 28b of the piston housing 28. When the piston 30 is in its rest position, the blade 12 is in an inoperative position likewise illustrated in FIG. 1. In the inoperative position of the blade 12, the blade 12 is located completely inside the blade housing 16 between the cutout 18 and the longitudinal end 16b of the housing 16.

The piston 30 further has a working position in which the piston 30 is disposed between the rest position and the end wall 28a of the piston housing 28. When the piston 30 is in the working position, the blade 12 is in an operative position. In the operative position of the blade 12, at least part of the cutting edge 14 of the blade 12 is in the cutout 18. Thus, in the operative position of the blade 12, the blade 12 is no longer completely inside the blade housing 16 and part of the blade 12 is outside of the housing 16.

Upon shifting of the piston 30 from the rest position to the working position, the spring 34 in the piston housing 28 is compressed. The spring 34 then urges the piston 30 back towards the rest position.

The piston 30, piston rod 32, plug 42, tube 38 and fastening element 40 are components of a means for moving the blade 12 from its inoperative position to its operative position. If the force-transmitting element comprising the piston rod 32, plug 42 and tube 38 is essentially inflexible, the piston 30 and force-transmitting element 32,42,38 push or thrust the blade 12 from its inoperative position to its operative position as the piston 30 moves from its rest position to its working position.

The piston 30 is driven by compressed fluid, and the removable cover 28b of the piston housing 28 is equipped with a valve 44 which functions to admit compressed fluid into the piston housing 28 and to exhaust the fluid from the piston housing 28. The valve 44 is provided with a connector 46 which is designed for connection to one end of a conduit 48 for compressed fluid. Compressed fluid is supplied to the valve 44 from a source of compressed fluid, and such source is here in the form of a tank or cylinder 50 containing a body of compressed fluid and having a connector 52 for connection to the other end of the conduit 48.

The conduit 48 can be in the form of a flexible hose or tube. The tank 50 is here assumed to be portable in the sense that it can be carried around by a person using the cutting device 10, e.g., by being strapped onto the back of a person using the cutting device 10. However, it is also possible to employ a tank which requires a cart for transportation or to employ a source of compressed fluid other than a tank.

The compressed fluid is advantageously compressed gas. Gases which could be used to drive the piston 30 include nitrogen and carbon dioxide although air is currently preferred.

The valve 44 is manually operated via a pushbutton 54 which has an extended position shown in FIG. 1. The pushbutton 54 also has a non-illustrated depressed position and is moved from the extended position to the depressed position, i.e., is depressed, by a person using the cutting device 10 when the latter is to cut an object. With the pushbutton 54 in its extended position and the piston 30 in its rest position, the valve 44 seals the interior of the piston housing 28 from the tank 50 and from the atmosphere.

The valve 44 and pushbutton 54 are designed in such a manner that the piston 30 is subjected to a single surge or burst of compressed fluid when the pushbutton 54 is depressed. Thus, when the pushbutton 54 is depressed, the valve 44 establishes a momentary connection between the tank 50 and the interior of the housing 28. Consequently, there is a sudden, brief discharge of compressed fluid into the piston housing 28 upon depression of the pushbutton 54, and the piston 30 is rapidly shifted from its rest position to its working position. In turn, the blade 12 is propelled from its inoperative position to its operative position.

As the piston 30 moves from its rest position to its working position, the spring 34 in the piston housing 28 is compressed and urges the piston 30 towards the rest position. While the piston 30 is urged from the working position to the rest position, the valve 44 establishes a connection between the atmosphere and the interior of the piston housing 28. This allows the fluid previously admitted into the piston housing 28 to be discharged from the latter as the piston 30 moves from the working position to the rest position under the action of the spring 34. Movement of the piston 30 from the working position to the rest position is accompanied by movement of the blade 12 from its operative position to its inoperative position.

Upon release of the pushbutton 54 following depression thereof, the pushbutton 54 returns to its extended position under the action of non-illustrated biasing means. The valve 44 seals the interior of the piston housing 28 from the atmosphere when the pushbutton 54 is in its extended position and the piston 30 is in its rest position.

The valve 44, conduit 48, tank 50 and pushbutton 54 constitute components of a means for effecting activation of the piston 30, piston rod 32 and tube 38.

The pushbutton 54 is preferably spaced from the cutout 18 by a distance which enables a user of the cutting device 10 to cut an object that would otherwise be out of the reach of the user. Typically, the distance between the pushbutton 54 and the cutout 18 will be in a range of about 1 to 2 times the height of an average person.

The axis B-B of the cutout 18 is advantageously inclined in such a manner that the axis B-B diverges from the piston 30, the piston rod 32, the tube 38, the valve 44 and the pushbutton 54 in a direction from the open end 18a of the cutout 18 to the closed end 18b of the cutout 18. This makes it easier for a user of the cutting device 10 to insert an object to be cut into the cutout 18, particularly when the object is not within the reach of the user.

One manner of operation of the cutting device 10 will be described assuming that a user of the cutting device 10 is attempting to cut a branch off a tree and that the branch is out of the reach of a person standing on the ground under the tree. It is further assumed that: (i) the blade 12 is initially in its inoperative position; (ii) the piston 30 is initially in its rest position; (iii) the valve 44 initially seals the interior of the piston housing 28 from the tank 50 and from the atmosphere; (iv) the pushbutton 54 is in its extended position; and (v) the tank 50 contains compressed air.

The user grips the piston housing 28 and the tubular housing 36 of the cutting device 10, and the user thereupon lifts the cutting device 10 to raise the blade housing 16 to a position above the branch to be cut. The blade housing 16 is oriented with the lower edge 24b of the housing 16 facing the branch, and the user lowers the housing 16 so that the portion of the lower edge 24b between the cutout 18 and the longitudinal end 16b comes to rest on the branch. The user then slides the housing 16 along the branch so that the cutout 18 is drawn towards the branch. Assuming that the diameter of the branch is smaller than the width of the cutout 18, the branch enters the cutout 18 when the latter reaches the branch. The user pulls on the cutting device 10 to bring the closed end 18b of the cutout 18 into contact with the branch.

As mentioned previously, the blade 12 is in its inoperative position and is thus fully retracted into the blade housing 16. Once the blade housing 16 has been properly positioned on the branch, the user depresses the pushbutton 54. When the pushbutton 54 is depressed, the valve 44 establishes a momentary connection between the tank 50 and the interior of the piston housing 28. In the course of this momentary connection, a burst of compressed air is released from the tank 50 and impinges on the piston 30. The burst of compressed air rapidly shifts the piston 30 from its rest position to its working position and, at the same time, compresses the spring 34 which bears against the piston 30.

Through the agency of the piston rod 32, the plug 42, the tube 38 and the fastening element 40, the piston 30 propels the blade 12 from its inoperative position to its operative position. In the operative position, the blade 12 is no longer confined entirely inside the blade housing 16 and projects into the cutout 18. During movement of the blade 12 from the inoperative position to the operative position, the cutting edge 14 of the blade 12 is thrust against the branch and cuts through the latter with a shearing action. The blade 12, which is pushed from the inoperative position to the operative position by the piston 30, is guided by the blade housing 16 while being moved from the inoperative position to the operative position.

Following arrival of the piston 30 at the working position, the spring 34 in the piston housing 28 begins to elongate and urges the piston 30 back towards its rest position. As the piston 30 is returned to the rest position, the valve 44 establishes a connection between the atmosphere and the interior of the piston housing 28. The air previously admitted into the piston housing 28 is thereupon pushed out of the latter by the piston 30 and evacuated into the atmosphere via the valve 44.

During movement of the piston 30 from the working position back to the rest position, the piston 30 draws or pulls the blade 12 from its operative position to its inoperative position. Thus, the blade 12 is once again fully retracted into the blade housing 16. The blade 12 is guided by the blade housing 16 as the blade 12 returns from the operative position to the inoperative position.

After the pushbutton 54 is depressed, the pushbutton 54 returns to its extended position under the action of non-illustrated biasing means once the pushbutton 54 is released by the user of the cutting device 10. The valve 44 once again seals the interior of the piston housing 28 from the atmosphere when the pushbutton 54 is in its extended position and the piston 30 is in its rest position.

It is preferred for the blade housing 16, piston housing 28 and tubular housing 36 to consist predominantly or essentially entirely of aluminum or an aluminum alloy. In the case of the blade housing 16, at least the plates 20 are favorably composed predominantly or essentially entirely of aluminum or an aluminum alloy. Likewise, the piston 30 advantageously consists predominantly or essentially entirely of aluminum or an aluminum alloy.

The piston rod 32 and the plug 42 can be made of an ordinary grade of steel while the tube 38 is preferably composed predominantly or essentially entirely of drawn-over-mandrel steel.

The piston housing 28 may be made from a single body of material, such as a casting or billet, which is bored to form a chamber for the piston 30, piston rod 32 and spring 34.

By way of example, the blade housing 16 can have a length of 9 inches and a height of 3 inches while the cutout 18 can be designed to receive an object having a maximum width or diameter of 1¼ inches. The tubular housing 36 may have a length of 9 feet, the tube 38 may have a length of 9¼ feet and the piston housing 28 may have a length of 5 inches.

If the tubular housing 36, the tube 38 and the piston housing 28 are cylinders of circular cross section, the tubular housing 36 can have a diameter of 1¼ inches, the tube 38 can have a diameter of 1 inch and the piston housing 28 can have a diameter of 4 inches.

The preceding dimensions are merely exemplary and are not given by way of limitation.

When the cutting device 10 is used with a tank or cylinder of compressed gas as the sole source of driving force for the piston 30, the cutting device 10 can be used indoors since it operates without combustion and does not generate combustion gases. Operation of the cutting device 10 with only a tank or cylinder of compressed gas as a source of driving force for the piston 30 also generates little noise.

By producing the blade housing 16, the tubular housing 36, the tube 38, the piston housing 28 and the piston 30 predominantly or essentially entirely from aluminum or aluminum alloys, the cutting device 10 can be made lightweight. This makes it easier for a person using the cutting device 10 to carry the latter.

Additionally, the cutting device 10 is quite simple since it has few parts.

Moreover, inasmuch as the blade 12 is fully retracted into the blade housing 16 when the cutting device 10 is not being used, the cutting device 10 reduces the chances of damage and injury.

Various modifications are possible within the meaning and range of equivalence of the appended claims.

I claim:

1. A cutting device comprising:
at least one housing;
a cutting element; and
means for moving said cutting element from an inoperative position to an operative position, said cutting element being completely inside said housing in said inoperative position and at least partially outside of said housing in said operative position.

2. The device of claim 1, wherein said moving means moves said cutting element from said inoperative position to said operative position using compressed fluid.

3. The device of claim 2, wherein said moving means moves said cutting element from said inoperative position to said operative position using compressed gas.

4. The device of claim 3, further comprising means for effecting activation of said moving means, said effecting means including a manually operable element that subjects said moving means to a single burst of compressed gas each time said manually operable element is operated to thereby rapidly shift said cutting element from said inoperative position to said operative position.

5. The device of claim 1, wherein said at least one housing defines a path for said cutting element, said path extending at least partway from said inoperative position to said operative position.

6. The device of claim 5, wherein said at least one housing comprises a pair of plates defining a gap and said gap has a marginal portion and an opposed second marginal portion, said housing further comprising a first spacer in said gap in said first marginal portion and a second spacer in said gap in said second marginal portion, and said plates and spacers cooperating to define said path.

7. The device of claim 1, further comprising another housing which is spaced from said at least one housing; and wherein said moving means includes a piston reciprocable in said another housing between a first position in which said cutting element is in said inoperative position and a second position in which said cutting element is in said operative position, said moving means also including a force-transmitting element bridging said at least one housing and said another housing, and said force-transmitting element having one end that adjoins said piston and another end which adjoins said cutting element.

8. The device of claim 7, wherein said force-transmitting element is substantially inflexible and said piston, said force-transmitting element and said cutting element are arranged such that said force-transmitting element pushes said cutting element from said inoperative position to said operative position in response to movement of said piston from said first position to said second position.

9. The device of claim 7, further comprising an additional housing between said at least one housing and said another housing, said additional housing bridging said at least one housing and said another housing, and said force-transmitting element extending through said additional housing, said additional housing comprising a tube.

10. The device of claim 9, wherein at least a major part of said force-transmitting element is tubular.

11. The device of claim 10, wherein said major part of said force-transmitting element consists essentially of drawn-over-mandrel steel.

12. The device of claim 10, wherein said at least one housing, said another housing and said additional housing consist predominantly of aluminum or an alloy thereof.

13. The device of claim 1, wherein said at least one housing is provided with a cutout for receiving an object to be cut, said cutting element projecting into said cutout in said operative position.

14. The device of claim 13, wherein said cutout has an open end, a closed end and an axis running between said open end and said closed end, said axis diverging from said moving means in a direction from said open end to said closed end so as to facilitate placement of said cutout over an object to be cut.

15. The device of claim 13, further comprising a manually operable element for effecting activation of said moving means, said cutout being spaced from said manually operable element by a distance such that a user operating said manually operable element can place said cutout over an object which is to be cut and is out of the reach of the user.

16. A cutting device comprising:
a first housing;
a cutting element;
a second housing spaced from said first housing;
an elongated tubular housing bridging said first housing and said second housing; and
means for moving said cutting element from an inoperative position to an operative position, said cutting element being at least partially inside said first housing in said inoperative position and at least partially outside of said first housing in said operative position, and said moving means including a piston reciprocable in said second housing between a first position in which said cutting element is in said inoperative position and a second position in which said cutting element is in said operative position, said moving means further including a substantially inflexible force-transmitting element which extends through said tubular housing, and said force-transmitting element having one end which adjoins said piston and another end which adjoins said cutting element, said piston, said force-transmitting element and said cutting element being arranged such that said force-transmitting element pushes said cutting element from said inoperative position to said operative position in response to movement of said piston from said first position to said second position.

17. The device of claim 16, further comprising means for effecting activation of said moving means, said effecting means including a source of compressed gas and being devoid of a motor.

18. The device of claim 16, wherein at least a major part of said force-transmitting element is tubular.

19. The device of claim 16, wherein said first housing, said second housing and said tubular housing consist predominantly of aluminum or an alloy thereof.

20. A cutting method comprising the steps of:
fully retracting a cutting element into a housing;
cutting at least partway through an object by propelling at least part of said cutting element out of said housing and against the object; and
fully retracting said cutting element into said housing following the cutting step.

21. The method of claim 20, wherein said part of said cutting element is propelled out of said housing compressed fluid.

22. The method of claim 21, wherein said part of said cutting element is propelled out of said housing compressed gas.

23. The method of claim 22, wherein the cutting step is performed by subjecting said cutting element to the action of a single burst of compressed gas so as to rapidly move said part of said cutting element towards the object to be cut.

24. The method of claim 20, further comprising the step of guiding said cutting element with said housing during the cutting step.

25. A cutting method comprising the steps of:
cutting at least partway through an object by pushing a cutting element out of an inoperative position and against the object, said cutting element being at least partially confined in a housing;
returning said cutting element to said inoperative position following the cutting step; and
guiding said cutting element with said housing during the cutting step and the returning step.
